(19) United States
(12) Patent Application Publication
(10) Pub. No.: US 2012/0285815 A1
(43) Pub. Date: Nov. 15, 2012

(54) SOLAR STILL ASSEMBLY

(75) Inventor: Peter Johnstone, Humevale (AU)

(73) Assignee: FIRST GREEN PARK PTY LTD, Victoria (AU)

(21) Appl. No.: 13/510,563

(22) PCT Filed: Nov. 16, 2010
(86) PCT No.: PCT/AU10/01533

§ 371 Date: Jul. 24, 2012

(30) Foreign Application Priority Data
Nov. 18, 2009 (AU) 2009905616
Sep. 23, 2010 (AU) 2010904294

(51) Int. Cl. C02F 1/14; B01D 3/00

(52) U.S. Cl. 202/267.1

(57) ABSTRACT

A solar energy treatment device such as a solar still for producing clean water from a contaminated or saline water source, the solar energy treatment device having at least one wall formed by a flexible plastic sheet member, the solar energy treatment device further including a rectangular or square perimeter frame with edge portions formed by an edge connector, each edge connector being formed by a first member defining a first elongated recess extending longitudinally along the first member, the edge connector also including a second member having a first elongated flange when in use projecting into the first elongated recess to retain an edge zone of the flexible plastic sheet member within the first elongated recess.

### PRIORITY CLAIM

The present application is a National Phase entry of PCT Application No. PCT/AU2010/001533, filed Nov. 16, 2010, which claims priority from Australian Patent Application No. 2009905616, filed Nov. 18, 2009, and Australian Patent Application No. 2010904294, filed Sep. 23, 2010, the disclosures of which are hereby incorporated by reference herein in their entirety.

### FIELD OF THE INVENTION

The invention relates to the construction of solar liquid treatment devices including solar stills intended to produce clean water condensate from saline, brackish or contaminated water supplies, with the use of solar energy.

### BACKGROUND OF THE INVENTION

International patent application no. PCT/AU2009/000503 discloses a solar still module of the above mentioned type having a treatment chamber defined essentially by spaced upper and lower sheets of flexible plastics material with preformed edge regions secured together by a number of tubular connector members. The upper flexible plastics material sheet is substantially clear so as to pass solar energy through the upper sheet into the treatment chamber in the space between the sheets. The solar still module has a treatment member conveniently formed as a tray mounted within the space between the upper and lower sheets of flexible plastic material such that the upwardly facing internal base surface of the tray faces the upper substantially clear flexible sheet of plastics material and is spaced below same to receive the solar energy passing through the upper wall defined by the upper flexible plastics material sheet. The solar still module is, in use, mounted to be inclined such that water or other liquid to be treated is delivered to an upper end region of the base surface of the tray and flows downwardly thereon to be subjected to solar energy, the moisture being evaporated and then condensed on the inner surface of the upper flexible plastics material sheet to flow downwardly thereon. This condensate or clean water may then be collected via the tubular connector member at the lower end of the solar still module. The disclosure of PCT/AU2009/000503, as far as is necessary to understand the following, is included in the present specification by this reference thereto.

The construction arrangements disclosed in International patent application no. PCT/AU2009/000503 for the solar still module work satisfactorily, however, it is desired to provide an improved construction arrangement solar energy treatment device of this type. It has also been recognized that utilizing flexible plastic material sheets for the upper and lower walls of the treatment device may result in the walls expanding by various mechanisms including thermal expansion, particularly with heat applied in use, thereby causing the walls to sag to a small degree. It has been found that polycarbonate sheeting or film will expand three to four mm's in about one metre width. It is preferable that these walls remain as taut as possible, with a small as possible air gap or space between the inner surfaces of the upper and lower walls and the treatment tray positioned therebetween as is possible. Moreover, as the clean condensate is flowing downwardly on the inner surface of at least the upper wall, it is also important that this surface avoid contact with the treatment tray below to avoid contamination of the clean condensate with the water on the treatment tray.

The objective of the present invention is to provide an improved construction, and parts thereof, for a solar energy treatment device of the above discussed type, that will overcome or minimize the difficulties with existing or known structures. It is a preferred objective to maintain a construction of solar energy treatment devices of the above discussed type that remains relatively low in cost.

### SUMMARY OF THE INVENTION

According to an embodiment, the present invention provides an edge connector means for forming a perimeter edge zone of a solar energy treatment device having at least one wall formed by a flexible plastic sheet member, the edge connector having a first member defining a first elongated recess extending longitudinally along the first member, the edge connector further including a second member having a first elongated flange adapted, in use, to project into the first elongated recess to retain an edge zone of the flexible plastic sheet member within the first elongated recess.

Conveniently, the edge zone of the flexible plastic sheet member includes a fold whereby a portion of the flexible plastic member sheet is positioned on opposite sides of the first elongated flange of the second member. Preferably the fold is preformed in the edge zone of the flexible plastic sheet member. Preferably the preformed fold is permanently formed in the edge zone.

In an embodiment, the first elongated flange of the second member is selectably positionable in the first elongated recess of the first member in at least two spaced positions whereby the first elongated flange is held at different depths of entry in the first elongated recess. In an embodiment, the first elongated flange includes at least one ratchet formation on one face of the first elongated flange, the or each ratchet formation being engageable with one or more inwardly projecting formations on an inner wall of the first elongated recess. Conveniently, multiple spaced ratchet formations may be formed on one face of the first elongated flange. The one or more inwardly projecting formation(s) on the inner wall of the first elongated recess may also be formed as a ratchet formation. Conveniently, multiple ratchet formations may be formed on the inner wall of the first elongated recess. In a further embodiment, the first member includes a second elongated flange located outwardly of the first elongated recess, the second elongated flange including ratchet formations to cooperate with ratchet formations on the second member to enable the second member to be selectably retained in at least two spaced positions. Conveniently, the or each of the aforesaid ratchet formations may extend fully along the first member and/or the second member forming the edge connector.

In a further embodiment, the second member may include a seal engageable, in use, with an outer surface of the flexible plastic sheet member. Conveniently the first member may include a conduit extending longitudinally along its length capable of receiving and carrying liquid including water. The first member may be formed as a tube or conduit.

The first member may define two first elongated recesses located spaced from each other, each of first elongated recesses being cooperable, in use with a separate flexible plastic sheet member by use of separate second members engaging in a respective first elongated recess. The first member may further include at least one and preferably two grooves positioned between the two spaced first elongated recesses.

In a further embodiment of this invention, there is provided a solar energy treatment device including four perimeter edge zones and two spaced upper and lower sheets of flexible plastic, each perimeter edge zone being formed by at least one edge connector as defined in the preceding paragraphs.

Preferably the first member and the second member of the edge connector may be formed by extrusion thereby having a uniform cross-section along their lengths. The first and second member may be extruded from a suitable aluminium or aluminium alloy. Alternatively, a solid or rigid plastics material could be used.

In yet another embodiment, the present invention provides a solar energy treatment device including a rectangular or square perimeter frame having two side edge frame members joined by two end edge frame members and a flexible plastic sheet member connected to the edge frame members forming an upper wall of the solar energy treatment device, an edge connector connecting the upper wall to the edge frame members, and at least one cross frame member engaging opposed edge frame members to urge the edge connector associated with the opposed edge frame members in an outward direction. Conveniently, the or each cross frame member extends between the side edge frame members intermediate the end frame members. The edge connector may be as described in the preceding paragraphs.

Embodiments will now be described with reference to the accompanying drawings.

### BRIEF DESCRIPTION OF THE DRAWINGS

FIG. 1 is an edge sectional view of a side edge zone of a solar energy treatment device including an edge connector according to a first embodiment;

FIG. 2 is an edge sectional view of an upper or a lower edge zone of a solar energy treatment device including an edge connector according to the first embodiment;

FIG. 3 is an edge sectional view of a side edge zone of a solar energy treatment device similar to FIGS. 1, 2, partially omitting certain features and showing a further embodiment;

FIG. 4 is a cross-sectional view showing in detail the second member used in the edge connector means illustrated in FIG. 3; and

FIGS. 5 and 6 show schematically stages in the production of a solar energy treatment device in accordance with an embodiment of the invention.

### DETAILED DESCRIPTION

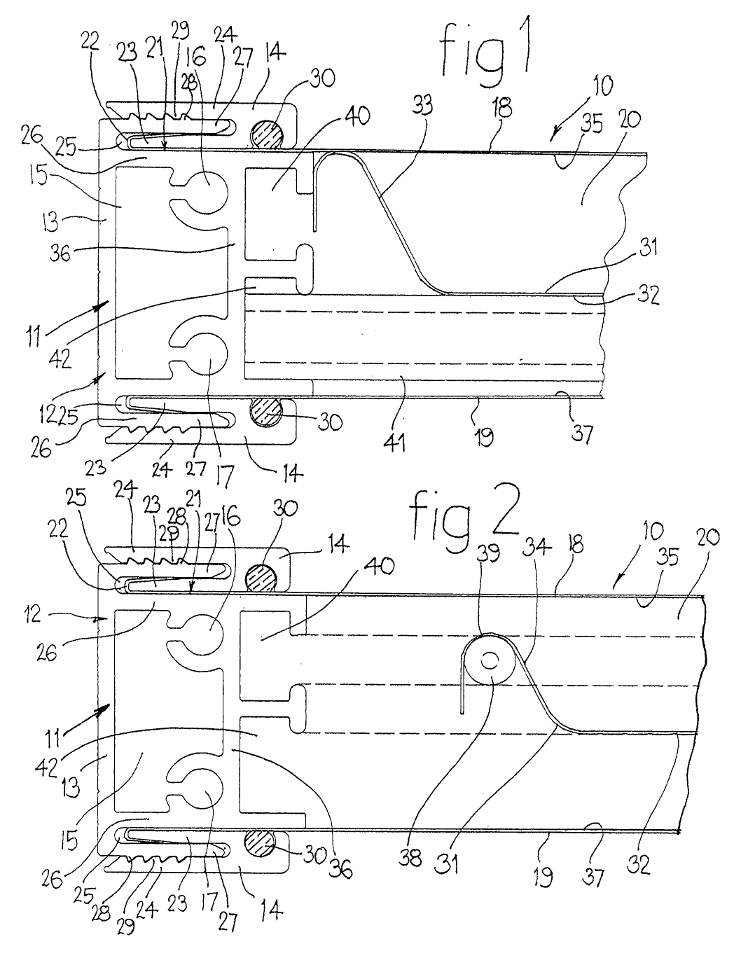

Referring to the drawings, each of FIGS. 1 and 2 show an edge region of a solar energy treatment module 10 according to a first embodiment, having a square or rectangular perimeter frame, the frame 11 having edge connector means 12 comprised of a first member 13 and a pair of second members 14. FIG. 1 represents either side edge zone of the frame 11 of the module 10 whereas FIG. 2 represents either the upper or the lower edge zone of the frame 11 of the module 10. The first member 13 is essentially rectangular in cross-section having a tubular shape with an internal space 15. The internal semicircular groove formations 16, 17 enable a desired length of the extrusion forming the first member 13 to be mitred at its ends and connected with similar such first members 13 by fasteners engaging in the formations 16, 17 to form a rectangular perimeter frame. Conveniently, the mitred joints at the ends of each length will include a suitable form of sealing gasket or other seal means to ensure the internal space 15 provides a continuous sealed zone except where inlet passages and outlet passages are formed specifically to allow liquid (water) to be introduced or removed from the space 15 as desired or from the treatment chamber 20.

The module 10 includes an upper wall 18 and a lower wall 19, each made from a stiff but flexible thin plastic material sheet. Conveniently, the upper wall 18 is substantially clear or highly translucent to allow solar energy to pass therethrough and into the treatment chamber 20 generally between the walls 18, 19. Peripheral edge zones 21 of the sheets forming the walls 18, 19 conveniently include a preformed fold 22 extending longitudinally along the edge zones 21. The second members 14 are formed as retainer strips and include a first flange 23 and a second flange 24 in a U-shaped configuration as illustrated. The first flange 23 is pressed into an elongated recess or groove 25 formed outwardly of the upper or lower walls 26 of the first member 13 defining the inner space 15, and inwardly of a flange 27. The outer surface of the flange 27 has outwardly formed and longitudinally extending ratchet formations 28 that engage with cooperable ratchet formations 29 on the inner surface of flange 24. The second members 14 also include seal formations 30 of any desired type to prevent ingress or egress of liquid (eg rain water) past the seal formation 30. Thus in use, the retainer strips 14 can be positioned with the flange 23 pressing the fold 22 into the groove 25. If the material of the walls 18, 19 stretches or expands in use, then the retainer strip 14 can be pressed further inwardly such that the flange 23 moves further into the recess or groove 25 to retighten the sheet material forming the walls 18, 19.

In a solar energy treatment device, the module 10 may include a treatment member or tray member 31 having a base wall 32, side walls 33 and upper and lower end walls 34. The structure and nature of the tray member 31 may be as described in International patent application no. PCT/AU2009/000503 and will not be described further in the present specification. Liquid to be treated such as saline, brackish or contaminated water is, in use, delivered to an upper end of the tray member 31 to flow downwardly on the base wall 32. Solar energy impinges on this liquid flow to at least partially evaporate same with water vapor condensing on the inner surface 35 of the upper wall 18. The condensate flows downwardly on the inner surface 35 to be collected in the lower regions of the chamber 20. One or more flow passages (not illustrated) may be positioned through the inner wall 36 of the member 13 to collect the clean condensate in the inner space 15. Some condensate may also form on the inner surface 37 of the lower wall 19 which also flows downwardly to the lower regions of the chamber 20. This occurs because water vapor circulates within the chamber 20 above and below the tray member 31 and around upper or lower edges of the tray member 31 (see FIG. 2). The tray member 31 may be supported by cross brace members 38 engaging beneath edge flanges 39 of the tray member 31. Ends of the cross brace members 38 may be supported within upper and inwardly facing grooves 40 in the first members 13. At least one longitudinally (up and down) brace member 41 is positioned to support the tray member 31 beneath its base wall 32. The ends of the brace member or members 41 may be supported in the lower inwardly facing groove 42 of the member 13. If desired, spacer members (not shown) may be positioned between the upper wall 18 and the base wall 32 of the tray member 31 to ensure separation between the condensate on the inner surface 35 of the wall 18 and the treatment liquid on the base wall 32 of the tray member 31. As disclosed in PCT/AU2009/000503, the spacer member or members may be separately formed members or may be integrally formed from the material of the tray member 31.

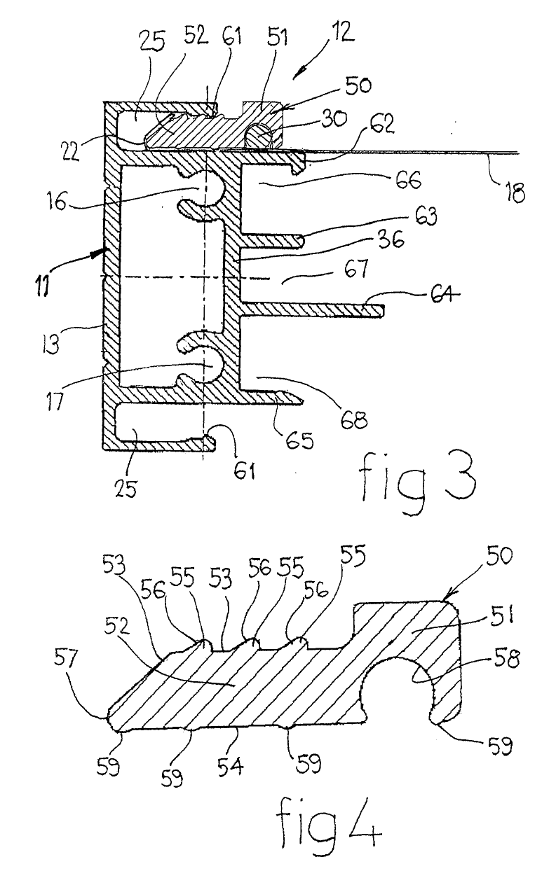

Reference will now be made to the alternative embodiment shown in FIGS. 3 and 4. In this embodiment the edge connector means 12 of the frame 11 has been modified to cooperatively interengage with a pair of second members 50. Each second member 50 includes a body portion 51 and a flange part 52 having opposed faces 53, 54. One of the flange faces 53 has multiple spaced ratchet formations 55, each having a forward sloping face 56 facing towards the free end 57 of the flange part 52. The body portion 51 includes a recess 58 to receive and hold a seal member 30 in the same manner as the embodiment of FIGS. 1, 2. The flange face 54 further includes spaced protuberances 59 adapted, in use to press the plastic sheet material of the upper wall 18 against a wall face of the elongated recess or groove 25. As shown in FIG. 3, similar to the earlier embodiments, the edge of plastic sheet material forming the upper wall 18 preferably has a preformed fold 22 formed in it such that a portion of the plastic sheet material engages both faces 53, 54 of the flange part 52. The inner face 60 of the elongated recess or groove 25 includes a projecting formation 61 that selectably engages, in use (FIG. 3), with one of the ratchet formations 55 on the flange part 52. Thus the second member 50 can be pushed into the recess 25 to engage more outwardly located ratchet formations 55 with the projecting formation 61 to increasingly stretch the material forming the upper wall 18. The inner wall 36 of the member 13 in the embodiment of FIG. 3, includes spaced inwardly projecting flanges 62, 63, 64 and 65 defining three grooves 66, 67 and 68. The flange 64 may be used to support and locate a tray member 31 (FIGS. 1, 2) and the grooves 66, 68 may be used to support spacer members to maintain the upper wall 18 in a desired location and similarly a lower wall (not shown) in a desired location.

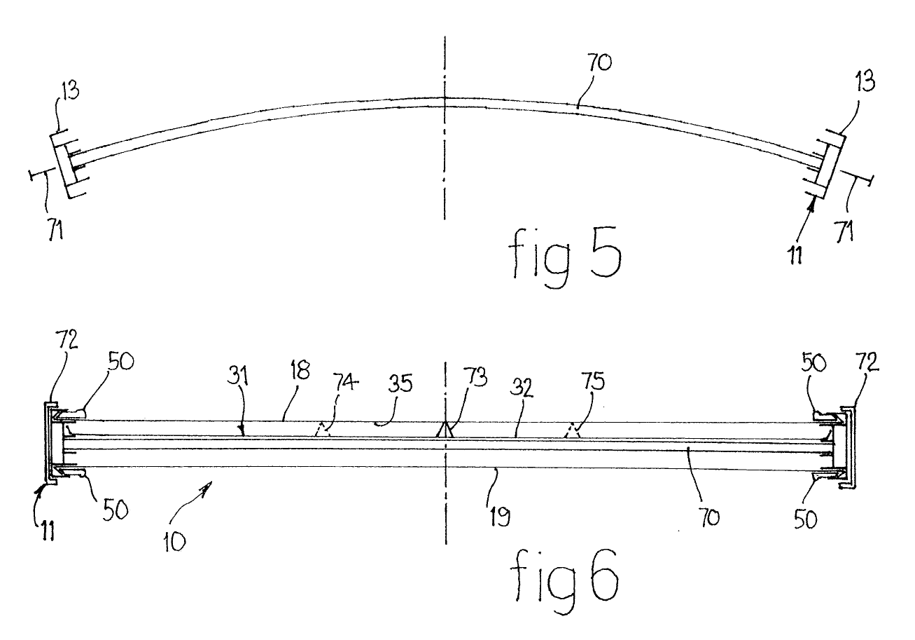

FIGS. 5 and 6 illustrate schematically, progressive stages in the assembly and manufacture of a solar energy treatment module 10 according to one embodiment of the present invention. In FIG. 5, a pair of spaced side first extruded aluminium members 13 have been initially formed into a rectangular perimeter frame 11 by joining same with end first extruded aluminium members 13 (not illustrated), the corners being mitred and connected as previously described. At least one and preferably multiple cross brace members 70 having a length slightly greater than the width between the side first members 13 are joined to the first members 13 by fasteners 71, typically, screw threaded fasteners. The cross brace members are spaced along the length of the side first members 13 and because they are slightly longer than the width between the members 13, they resiliently bow as illustrated in a slightly exaggerated manner as shown in FIG. 5. At the same time the side members 13 are angled outwardly also as represented in a slightly exaggerated manner in FIG. 5. Subsequently, the perimeter frame including the cross brace members 70 are placed in a supporting jig 72 (FIG. 6) with the upper wall 18 of a clear or highly translucent stiff but flexible thin plastic material sheet is secured as previously described by second members 50 to the first members 13. Preferably, at least one longitudinal support 73 or two spaced longitudinal supports 74, 75 are positioned between the inner surface of the upper wall 18 and the base wall 32 of the tray member 31. Conveniently, when the module 10 is released from the jig 72, the cross brace members 70 seek to recover the bowed shape represented in FIG. 5 and in doing so, causes an increased level of cross or transverse stretching on the upper wall 18 secured by the second members 50 to the side first members 13. Thus when temperature of the upper wall 18 increases during use and the material of the wall 18 expands, slightly, the increased cross tension in the material still retains a taut upper wall with the inner surface 35 well spaced from the base wall 32 of the tray member 31.

The lower wall 19 might be secured in position while the module 10 is retained in the jig 72 or after it has been released therefrom. The materials for the upper and lower walls 18, 19 and the materials and configurations of the tray member 31 may be as described in international patent application no. PCT/AU2009/000503.

While the annexed drawings illustrate embodiments of the present invention, it will be appreciated that modifications could be made within the scope of the annexed claims.

1. An edge connector for forming a perimeter edge zone of a solar energy treatment device having at least one wall formed by a flexible plastic sheet member, said edge connector having a first member defining a first elongated recess extending longitudinally along said first member, said edge connector further including a second member having a first elongated flange adapted, in use, to project into said first elongated recess to retain an edge zone of said flexible plastic sheet member within said first elongated recess.

2. An edge connector according to claim 1 wherein the edge zone of said flexible plastic sheet member includes a fold whereby a portion of said flexible plastic member sheet is positioned on opposite sides of said first elongated flange of the second member.

3. An edge connection according to claim 2 wherein said fold is preformed in the edge zone of said flexible plastic sheet member.

4. An edge connector according to claim 1 wherein the first elongated flange of the second member is selectably positionable in said first elongated recess of the first member in at least two spaced positions whereby the first elongated flange is held at different depths of entry in said first elongated recess.

5. An edge connector according to claim 4 wherein the first elongated flange includes at least one ratchet formation on one face of said first elongated flange, the or each said ratchet formation being engageable with one or more inwardly projecting formations on an inner wall of said first elongated recess.

6. An edge connector according to claim 5 wherein multiple spaced said ratchet formations are formed on said one face of said first elongated flange.

7. An edge connector according to claim 5 wherein said one or more inwardly projecting formation on the inner wall of said first elongated recess are formed as a ratchet formation.

8. An edge connector according to claim 7 wherein multiple said ratchet formations are formed on the inner wall of said first elongated recess.

9. An edge connector according to claim 4 wherein said first member includes a second elongated flange located outwardly of said first elongated recess, said second elongated flange including ratchet formations to cooperate with ratchet formations on said second member to enable said second member to be selectably retained in said at least two spaced positions.

10. An edge connector according to claim 5 wherein the or each said ratchet formation extends fully along said edge connector means.

11. An edge connector according to claim 1 wherein the second member includes a seal engageable, in use, with an outer surface of the flexible plastic sheet member.

12. An edge connector according to claim 1 wherein the first member includes a conduit extending longitudinally along its length capable of receiving and carrying liquid.

13. An edge connector according to claim 1 wherein said first member defines two said first elongated recesses located spaced from each other, each of said first elongated recesses being cooperable, in use with a separate said flexible plastic sheet member by use of separate said second members engaging in a respective said first elongated recess.

14. An edge connector according to claim 13 further including at least one elongated groove between said two spaced first elongated recesses.

15. A solar energy treatment device including four perimeter edge zones and two spaced upper and lower sheets of flexible plastic, each said perimeter edge zone being formed by at least one edge connector according to claim 1.

16. A solar energy treatment device including a rectangular or square perimeter frame having two side edge frame members joined by two end edge frame members and a flexible plastic sheet member connected to said edge frame members forming an upper wall of said solar energy treatment device, an edge connector connecting said upper wall to said edge frame members, and at least one cross frame member engaging opposed said edge frame members to urge said edge connector associated with said opposed edge frame members in an outward direction.

17. A solar energy treatment device according to claim 16 wherein the or each said cross frame member extends between said side edge frame members intermediate said end frame members.

18. A solar energy treatment device according to claim 16 wherein the edge connector is as defined in claim 1.
